(19) United States
(12) Patent Application Publication
(10) Pub. No.: US 2013/0194985 A1
(43) Pub. Date: Aug. 1, 2013

(54) Methods and Apparatus for In-Device Coexistence

(71) Applicants: Tommi Juhani Zetterman, Espoo (FI); Antti-Veikko Sakari Piipponen, Vantaa (FI); Sami Olavi Johannes Kiminki, Helsinki (FI); Jussi Petteri Knuuttila, Helsinki (FI); Vesa Lauri Ilmari Hirvisalo, Helsinki (FI)

(72) Inventors: Tommi Juhani Zetterman, Espoo (FI); Antti-Veikko Sakari Piipponen, Vantaa (FI); Sami Olavi Johannes Kiminki, Helsinki (FI); Jussi Petteri Knuuttila, Helsinki (FI); Vesa Lauri Ilmari Hirvisalo, Helsinki (FI)

(73) Assignee: Nokia Corporation

(21) Appl. No.: 13/359,906

(22) Filed: Jan. 27, 2012

(51) Int. Cl. H04W 52/02

(52) U.S. Cl. 370/311

(57) ABSTRACT

Systems and techniques for improved in-device coexistence. A base station defines a DRX cycle for a user equipment including defining at least one scheduling timer, such that a downlink HARQ process can be initiated only when the scheduling timer is active and an uplink HARQ process can be initiated only while the at least one scheduling timer is active. Alternatively, a DRX cycle is defined so as to include a measurement gap during which HARQ retransmissions are skipped during the measurement gap.

### TECHNICAL FIELD

The exemplary and non-limiting embodiments of this invention relate generally to wireless communication, and more specifically relate to mechanisms for scheduling cellular network communication by a device so as to allow for interference-free periods by other communication mechanisms of the device.

### BACKGROUND

As wireless devices increase in capability and as miniaturization of electronics continues to develop, more and more devices are being designed so as to combine different communication mechanisms on a single device. Unless carefully managed, such designs may cause interference between dissimilar radio transmitters and receivers. On some LTE frequency bands, radiofrequency interference between dissimilar transmitters and receivers, such as LTE, WLAN, Bluetooth, or GPS, may be too strong to filter out. Efficient use of radio resources may lead to the use of narrow guard bands or communication that does not use guard bands at all.

Particularly if such an approach is used, designs that place dissimilar transmitters and receivers close to one another, may cause interference that is too strong to filter out. Management of such interference may, for example, take the form of handing over a UE experiencing such interference to an uninterfered frequency. Alternatively, the UE may be provided with unscheduled periods to be used by co-located radios. Such an approach is known as time-domain multiplexing (TDM).

### SUMMARY

According to one embodiment of the invention, an apparatus comprises at least one processor and memory storing a program of instructions. The program of instructions is configured to, with the memory and the at least one processor, configure the apparatus to perform actions comprising at least defining a discontinuous reception cycle, wherein the discontinuous reception cycle defines configuring at least one scheduling timer communication with the user device and performing at least one of scheduling a downlink hybrid automatic repeat request process if the at least one scheduling timer is active and granting an uplink hybrid automatic repeat request process by the user device if transmission of the hybrid automatic repeat request process is due before the at least one scheduling timer expires.

According to another embodiment of the invention, a method comprises defining a discontinuous reception cycle, wherein the discontinuous reception cycle defines configuring at least one scheduling timer communication with the user device and performing at least one of scheduling a downlink hybrid automatic repeat request process if the at least one scheduling timer is active and granting an uplink hybrid automatic repeat request process by the user device if transmission of the hybrid automatic repeat request process is due before the at least one scheduling timer expires.

According to another embodiment of the invention, a computer readable medium stores a program of instructions. Execution of the program of instructions by a processor configures an apparatus to perform actions comprising at least defining a discontinuous reception cycle for a user device, wherein the discontinuous reception cycle defines at least one of configuring a downlink scheduling timer for downlink communication to the user device and an uplink scheduling timer for uplink communication to the user device, and performing at least one of scheduling a downlink hybrid automatic repeat request process to the user device only if the downlink scheduling timer is active and granting a uplink hybrid automatic repeat request process by the user device if a transmission of the hybrid automatic repeat request process is due before the uplink scheduling timer expires.

According to another embodiment of the invention, an apparatus comprises at least one processor and memory storing a program of instructions. The program of instructions is configured to, with the memory and the at least one processor, configure the apparatus to perform actions comprising at least requesting a base station to configure a discontinuous reception cycle for the apparatus, wherein the requested discontinuous reception cycle comprises at least one of scheduling timer for the apparatus, wherein the at least one of scheduling timer defines time limits during which at least one of uplink and downlink hybrid automatic repeat request processes may be initiated.

According to another embodiment of the invention, an apparatus comprises at least one processor and memory storing a program of instructions. The program of instructions is configured to, with the memory and the at least one processor, configure the apparatus to perform actions comprising at least defining a discontinuous reception cycle for a user device, wherein the discontinuous reception cycle includes a measurement gap such that hybrid automatic repeat request process retransmissions are skipped during the measurement gap.

These and other embodiments and aspects are detailed below with particularity.

### BRIEF DESCRIPTION OF THE DRAWINGS

FIG. 1 illustrates a wireless network cell in which operate elements according to an embodiment of the present invention;

FIG. 2 illustrates a process according to an embodiment of the present invention;

FIG. 3 illustrates a discontinuous reception cycle defined according to an embodiment of the present invention;

FIG. 4 illustrates an exemplary operation conducted according to an embodiment of the present invention;

FIGS. 5A-5C illustrate results of variations of an exemplary operation conducted according to an embodiment of the present invention;

FIG. 6 illustrates a discontinuous reception cycle defined according to an embodiment of the present invention;

FIG. 7 illustrates results of the use of a discontinuous reception cycle defined according to an embodiment of the present invention; and

FIG. 8 illustrates a process of configuration and use of a discontinuous reception cycle according to an embodiment of the present invention.

### DETAILED DESCRIPTION:

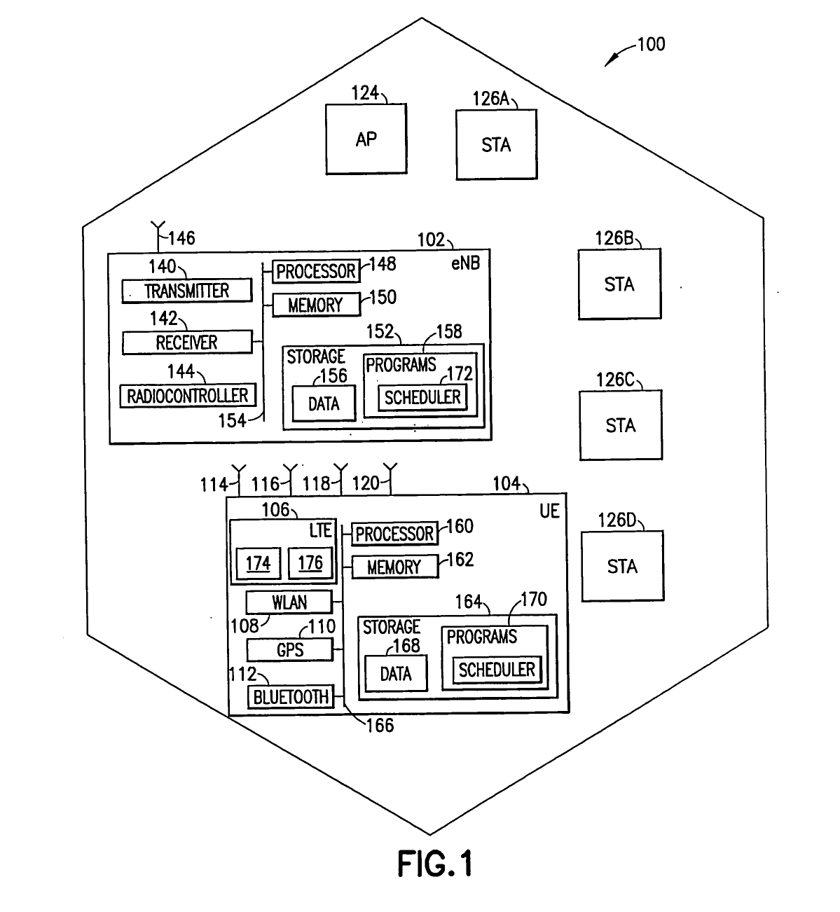

FIG. 1 illustrates details of wireless network cell 100 in which operate elements according to embodiments of the present invention. The cell 100 may be defined as a geographic area served by a base station, here implemented as an eNodeB (eNB) 102. Also present in the cell 100 are a user device, suitably referred to as a user equipment (UE) 104, according to an embodiment of the present invention. The UE 104 may comprise an LTE module 106, a wireless LAN (WLAN) module, 108, a GPS module 110, and a Bluetooth module 112. The modules 106, 108, 110, and 112 employ antennas 114, 116, 118, and 120, respectively. The various antennas 114-120 lie close to one another and can cause intolerable interference if their operation is not managed to prevent it. Embodiments of the present invention provide for periods of inactivity of a of the LTE module 106, the WLAN module 108, the GPS module 110, as well as other radio modules that may be present in a UE such as the UE 104.

Also present in the cell 100 are a wireless LAN access point (AP) 124 and WLAN STAs 126A-126D. The module 108 will periodically need to communicate with the AP 124, and embodiments of the present invention manage the activity of the module 106 so that the module 108, as well as the other modules 110 and 112, can have reasonable opportunities to communicate.

Embodiments of the present invention recognize that current 3GPP specifications for LTE discontinuous reception (DRX) do not guarantee any particular inactivity periods, and are not predictable from the perspective of a UE. One characteristic of 3GPP specifications is that the standard does not provide any in-advance guaranteed idle period when a UE does not need to monitor the physical downlink control channel (PDCCH) if the UE is in connected mode. This causes particular difficulties when a co-located radio transmitter interferes with LTE downlink reception. Prior art LTE system techniques account only for intra-system interference, so uncoordinated interference from other systems can affect the LTE system as a whole. Embodiments of the present invention therefore provide mechanisms to prevent a co-located radio from transmitting if it would cause significant interference when an LTE radio is monitoring the PDCCH. One mechanism that is contemplated for time domain multiplexing (TDM) of the LTE and other radios is the use of discontinuous reception (DRX). The DRX mechanism defines a DRX period with a DRX ON period that may be followed by a DRX OFF period.

At the start of a DRX ON portion, a UE such as the UE 100 (specifically, the LTE module 106 of the UE 104), monitors the PDCCH for a predetermined on-duration. The on-duration may be extended by an inactivity timer, and after the inactivity timer expires, the LTE module 106 enters a sleep state for an off-duration, which extends until the beginning of the next DRX cycle. The inactivity timer is reset whenever new data is scheduled. If an eNB such as the eNB 102 continues to schedule new data for a UE, the inactivity timer may never expire and the UE's LTE module may never enter the sleep state. So long as the UE needs to monitor the PDCCH, any co-located radios, such as the WLAN module 104 or Bluetooth module 106 in the case of the UE 100, for example, will be unable to transfer data because the monitoring of the PDCCH being performed by the LTE module 102 cannot tolerate the interference.

In one contemplated mechanism, the UE 104 may suggest a DRX pattern, such as a 40 ms scheduling period and a 40 ms unscheduled period. The DRX cycle in this case would be 80 ms. The eNB 102 would use smart scheduling to create a suitable DRX configuration. Such an approach is described in 3GPP TR 36.816. However, a number of problems impair the usefulness of this approach, some of which are shown in R2-114105. If an inactivity period is to be guaranteed, the eNB needs to stop scheduling data significantly before the DRX on-duration ends, because HARQ re-transmissions can potentially extend for a relatively long time. With typical DRX parameters, re-transmissions may extend for as much as 32 ms.

Embodiments of the present invention address these and other problems by providing mechanisms to manage scheduling for LTE operations, such as by the LTE module 106 for a UE such as the UE 104 in such a way as to allow transmission opportunities by co-located transmitters. In one embodiment of the invention, the eNB 106 may comprise a transmitter 140, receiver 142, antenna 144, and radiocontroller 146. The eNB 102 may also comprise a processor 148, memory 150, and storage 152, communicating with one another and with the radiocontroller 146 over a bus 154. The eNB 102 suitably employs data 156 and programs 158, suitably residing in storage 152 and transferred to memory 150 as needed for use by the processor 148.

The UE 104 may suitably employ a processor 160, memory 162, and storage 164, communicating with one another and with the modules 106-112 over a bus 166. The UE 104 also employs data 168 and programs 170, suitably residing in storage 164 and transferred to memory 162 as needed for use by the processor 160.

The eNB 102 may employ an eNB scheduler 172 as part of the programs 158, in order to manage resource scheduling for the various LTE UEs that it serves, and the UE 104 and eNB 102 employ mechanisms according to embodiments of the present invention to manage downlink and uplink scheduling of the eNB scheduler 172, in order to provide reception and transmission gaps exhibiting coexistence-friendly properties.

The eNB scheduler 172 suitably configures two scheduling timers, defined as ulSchedulingTimer and dlSchedulingTimer, where ulSchedulingTimer is an uplink scheduling timer and dlSchedulingTimer is a downlink scheduling timer. When enabled, these timers define a duty cycle for scheduling within the DRX cycle. A UE needing to define scheduling for coexistence—in the present exemplary case, the UE 104—requests configuration of the timers by the eNB 102, and the eNB scheduler 172 configures the timers and controls the eNB 102 to confirm to the UE 104 that the timers have been configured. The UE 104 is thus able to request a DRX duty cycle as needed. New HARQ processes may be instantiated only inside the duty cycle. Therefore, when the duty cycle ends and ongoing HARQ processes are terminated, an LTE transmitter 174 and receiver 176 used by the LTE module 106 may be powered off until the next DRX cycle. The time that the transmitter 174 and receiver 176 are powered off may then be used by other radio systems without interference.

The UE 104 may employ a configuration request module 178, suitably implemented as part of the programs 170, providing the UE 104 with the capability to request that the eNB 102 configure particular DRX cycles, such as a cycle employing the ulSchedulingTimer and dlSchedulingTimer described above. The configuration request module 178 may specify particular values for the ulSchedulingTimer and dlSchedulingTimer, as well as a drx-InactivityTimer, all of which may be used by the eNB scheduler 172 to manage scheduling of the UE.

It will be recognized that the use of a separate ulSchedulingTimer and dlSchedulingTimer is exemplary only, and that numerous alternative embodiments may be employed. For example, in one embodiment, a single timer may be used for uplink and downlink scheduling.

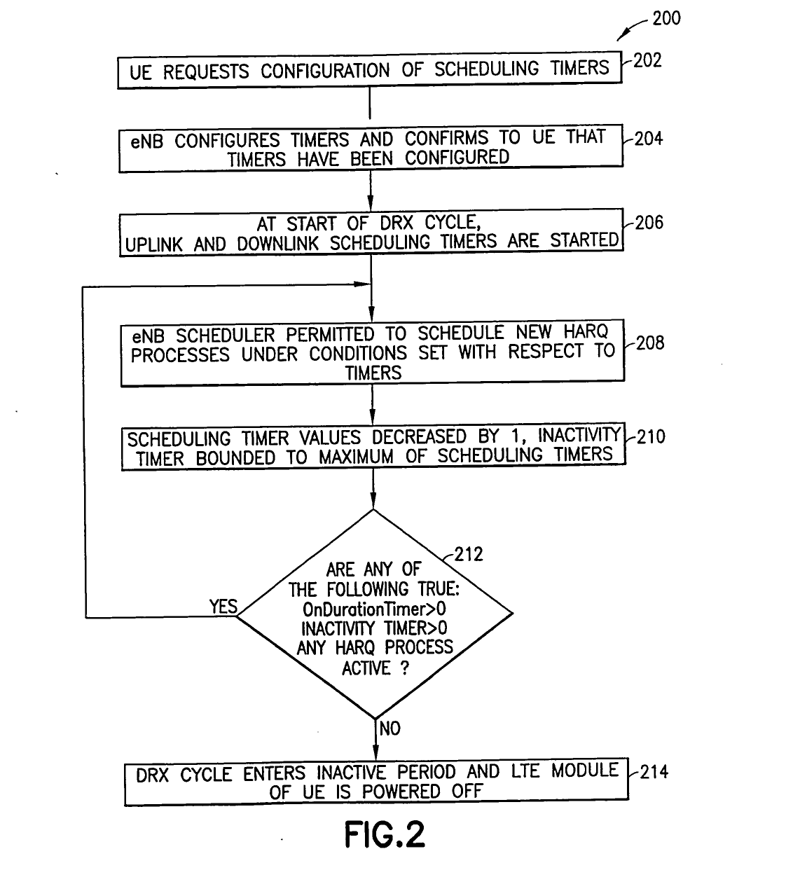

FIG. 2 illustrates a process of resource management according to an embodiment of the present invention. At step 202, a UE requests configuration of scheduling timers from an eNB. At step 204, the eNB configures the timers and confirms to the UE that the timers have been configured. The timers that are configured are dlSchedulingTimer and ulSchedulingTimer.

At step 206, at the start of a DRX cycle, dlSchedulingTimer and ulSchedulingTimer are started. A drx-InactivityTimer is also bounded to be at most the maximum of (dlSchedulingTimer, ulSchedulingTimer).

At step 208, the eNB scheduler 172 manages uplink and downlink HARQ processes. For example, a new downlink HARQ process may be scheduled if the dlSchedulingTimer is active. A new uplink HARQ process may be granted, with the first transmission of that HARQ process being postponed when the ulSchedulingTimer has expired. In another alternative, an uplink grant may be issued if the first uplink HARQ transmission will occur while the ulSchedulingTimer is active.

At step 210, occurring after the conclusion of each subframe, the value of dlSchedulingTimer and ulSchedulingTimer are decreased by 1, and the drx-InactivityTimer is bounded to the maximum of (dlSchedulingTimer, ulSchedulingTimer).

At step 212, the expiration of onDurationTimer, the expiration of drx-InactivityTimer, and the termination of HARQ processes are evaluated. If the onDurationTimer and the drx-InactivityTimer are expired, and all HARQ processes are terminated, the process proceeds to step 214. Otherwise, the process returns to step 208.

At step 214, the DRX cycle enters an inactive period and the LTE module of a UE is powered off. At the end of the DRX cycle, the process returns to step 206 to begin a new DRX cycle.

Until the new DRX cycle, the off-cycle can be interrupted only by UE-oriented activity, such as a scheduling request. By postponing these activities, the off-cycle may be completely utilized by companion radios without the risk of in-device interference. The scheduling timers described here guarantee that no new data may be scheduled outside the scheduling duty cycle. Unless HARQ processes frequently require multiple retransmissions, which is usually unlikely, the UE is statistically guaranteed to enter off-cycle with high probability, provided that scheduling timers are sufficiently shorter than the DRX cycle.

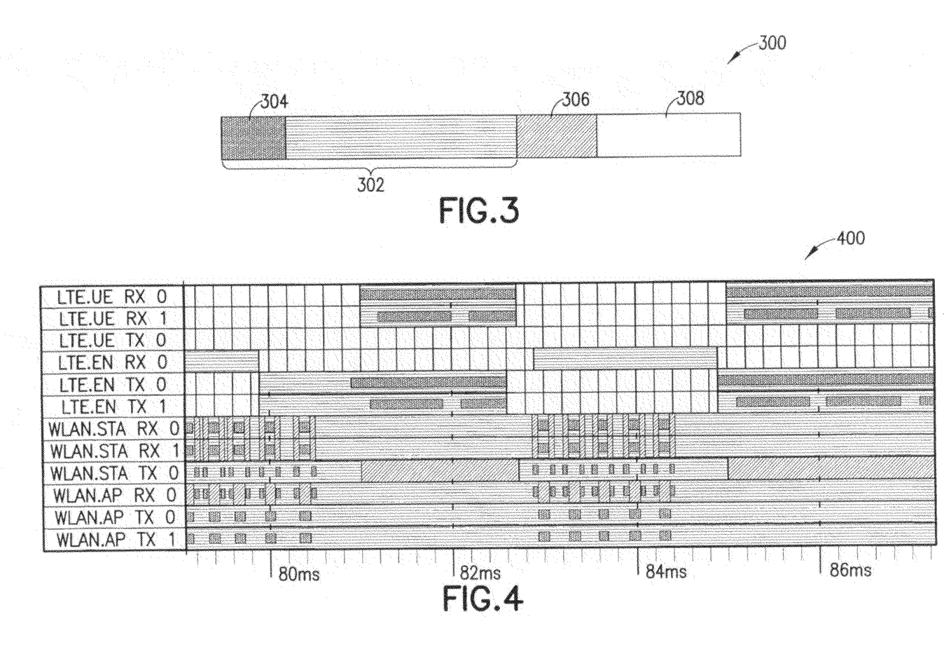

FIG. 3 illustrates an exemplary DRX cycle 300, exhibiting scheduling duration configured according to one or more embodiments of the present invention. The DRX cycle 300 comprises a scheduling duration 302, of which a portion is dedicated to an On-duration 304. The DRX cycle further comprises a HARQ termination duration 306 and an Off-duration 308.

The bounding of the drx-InactivityTimer by the scheduling timers guarantees that the drx-InactivityTimer cannot be active when the scheduling timers are expired. After expiration of the scheduling timers, of course, no new data may appear. It will be recognized that the drx-InactivityTimer may expire before the scheduling timers, when there is no data to be transferred. Therefore, if the drx-InactivityTimer expires before the scheduling timers, the UE may enter the DRX off-cycle before the scheduling timers expire.

It is to be expected that the UE will have the best overview of its in-device interference situation and the data transfer pressures of its companion radios, so that the UE is in a good position to request configuration of scheduling timers. A request for scheduling timers should be considered as a request for voluntary service level degradation for inter-radio load balancing in the UE. The eNB has the ability to override scheduling requests from a UE and impose specific scheduling timer values to ensure that the minimum service level requirements will be met in the current network environment. Also, the eNodeB may adjust other information elements such as drxStartOffset, to prevent congestion on specific subframes, in accordance with conventional DRX mechanisms.

FIG. 4 illustrates a chart 400 presenting the conditions of a simulation performed to show the effectiveness of scheduling performed according to embodiments of the present invention. Performance was analyzed on a combined LTE-WLAN multi-radio with in-device interference scenario. It was assumed that the transmitter of the LTE radio interferes with the WLAN reception and that the WLAN station cannot transmit while the LTE receiver is active. Such a scenario may apply, for example, in LTE band 40 and WLAN channel 1 interference scenarios. In the scenario illustrated in FIG. 4, LTE uses TDD frame structure configuration 1. The DRX parameters used were: cycle=80 ms, on-duration=5 ms, inactivity=5 ms. Values of dlSchedulingTimer and DL HARQ retransmission probability were varied.

WLAN operates on 802.11n standard on power-save mode without frame aggregation. The workloads evaluated were downlink-only, and designed to provide as much throughput as possible.

The scenario presented at FIG. 400 is for a single network user. For multiple network users, the results should be scaled down appropriately, but the overall shape of the behavior should not change. The simulator used is a MAC-level multi-radio simulator, which follows communication timing accurately.

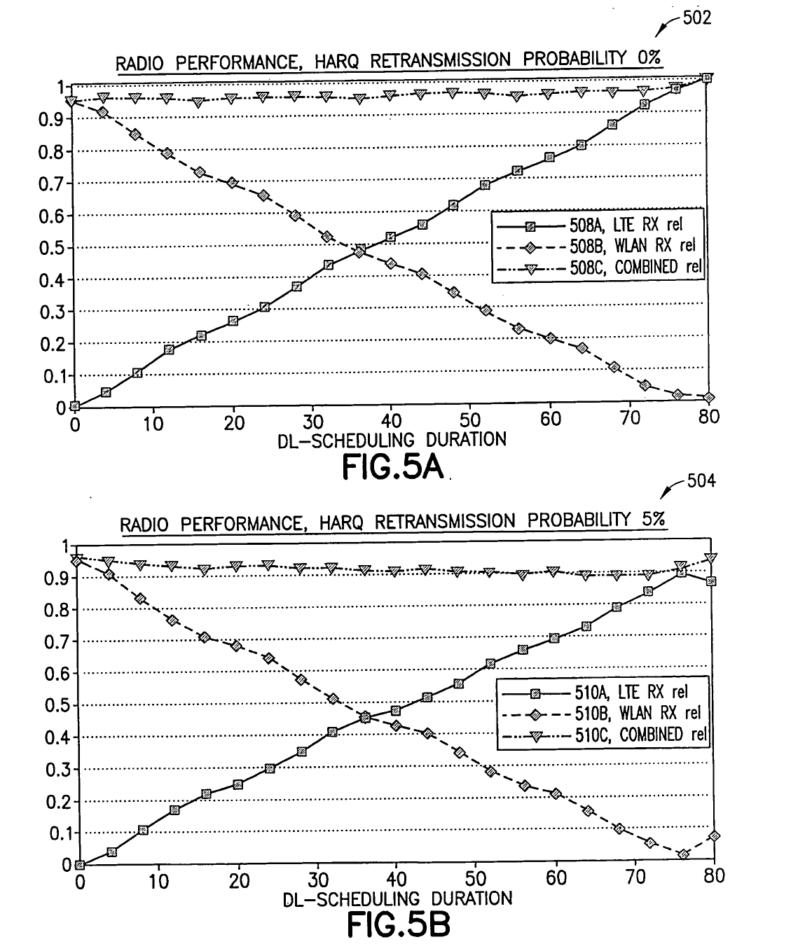

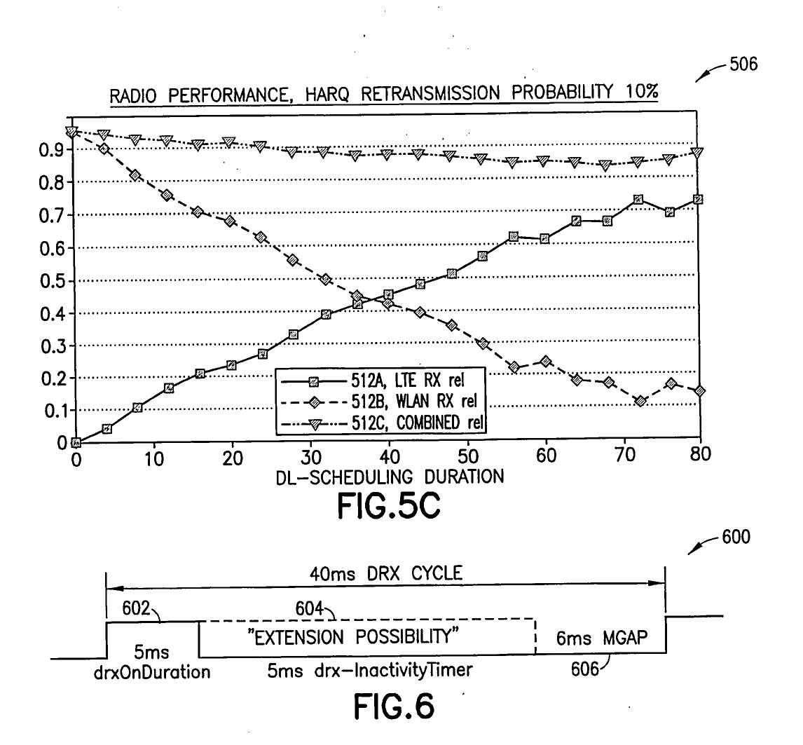

FIGS. 5A-5C illustrate graphs 502-506 illustrating performance results for the scenario presented in FIG. 4, with the graph 502 showing results for HARQ retransmission probability of 0%, the graph 504 showing results for HARQ retransmission probability of 5%, and the graph 406 showing results for HARQ retransmission probability of 10%. The graph 502 presents curves 508A-508C, illustrating LTE reception performance, WL reception performance, and combined reception performance, respectively. The graph 504 presents curves 510A-510C, illustrating LTE reception performance, WL reception performance, and combined reception performance, respectively. The graph 506 presents curves 512A-512C, illustrating LTE reception performance, WL reception performance, and combined reception performance, respectively. The throughputs are scaled on a relative scale, where 1 represents the non-interfered maximum throughput. The simulation results show that the overhead for the total system performance is approximately 5% regardless of the used dlSchedulingTimer value. The overhead is consistent over different HARQ retransmission probabilities, which is indicated by the straightness of the line representing the combined relative performance.

The results from fitting WLAN traffic into non-interfered time intervals and the non-terminated HARQ processes when dlSchedulingTimer expires. HARQ ACKs do not carry data but block WLAN traffic. It will be noted that with high HARQ retransmission probability it is possible that the DRX inactivity timer may expire due to retransmissions, so that the DRX off-cycle will be entered. This explains why WLAN throughput does not reach 0 Mb/s when dlSchedulingTimer reaches the DRX cycle with HARQ retransmission probability 10%.

In one or more additional embodiments of the invention, measurement gaps are aligned with the DRX cycle. The measurement gaps may suitably be implemented by the eNB scheduler 172 of the eNB 102, and may be specified by the configuration 178 of the UE 104. The measurement gap may be positioned at the end of the DRX cycle, immediately before the start of the on-duration. Existing definitions have a period of 40 and 80 ms, and the gap length is always 6 ms; this means that suitable DRX cycle lengths are 40, and 80 ms. It will be recognized that the use of a measurement gap may be accomplished in any number of ways. The purpose of the measurement gap is to give other components of a UE an opportunity to transmit, and they need not necessarily transmit at every DRX cycle. The eNB scheduler therefore might configure a measurement gap at every second DRX cycle, every third DRX cycle, and so on.

The on-duration timer can be set to any value, but to allow better UE power saving, short values may be preferred. By setting a suitable drx-InactivityTimer the active time can then be extended by scheduling new data for as long as there is some. Also the HARQ re-transmissions could occur also after the expiry of the on-duration timer. During the measurement gap, all HARQ re-transmissions are skipped, and re-scheduled after the gap.

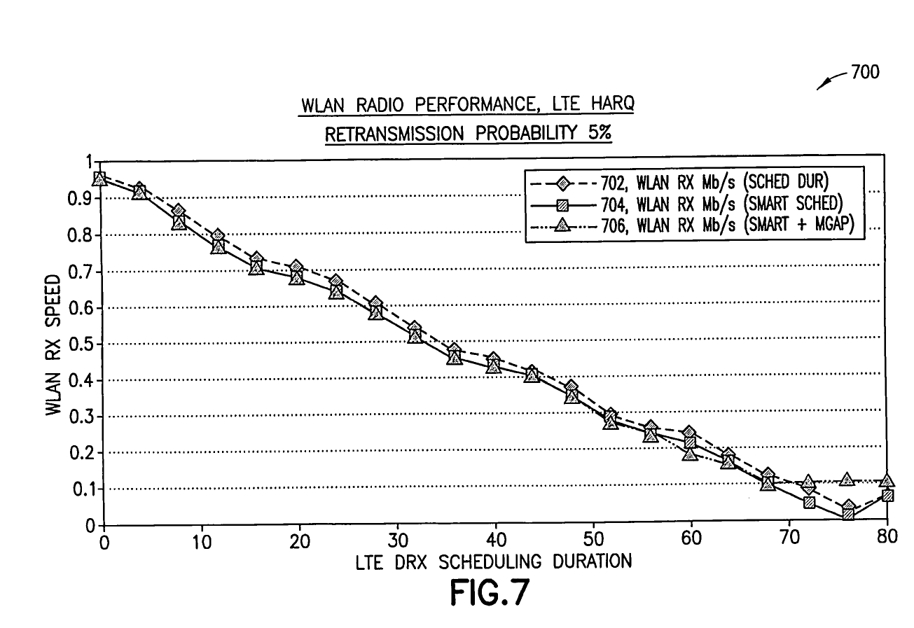

FIG. 6 illustrates a 40 ms DRX cycle 600, with a 5 ms drxOnDuration, an extension possibility, which can be provided for example by a 5 ms drx-InactivityTimer, and an effective measurement gap of 6 ms. The measurement gap may suitably be 6 ms for downlink and 7 ms for uplink. The extra 1 ms compensates for timing advance, yielding a usable measurement gap of 6 ms. The scheduling duration extension was compared against existing DRX using the same settings (80 ms cycle, 5 ms on-duration, 5 ms inactivity timer), and the results of the comparison are shown in FIG. 7, presenting a graph 700. Without the scheduling duration, smart eNB scheduling is needed to guarantee inactivity for the UE—the eNB stops scheduling new data at some point within the DRX cycle. The UE will listen for PDCCH during the inactivity time, which is overhead from coexistence point of view. The results in FIG. 7 show expected behavior—a scheduling duration extension eliminates this overhead, boosting WLAN throughput by about 6%. This result is shown in the curve 702. FIG. 7 also shows smart scheduling at the curve 704, as well as smart scheduling with a measurement gap, at the curve 706. The measurement gap, at an 80 ms cycle, guarantees approximately a 10% time-share for the WLAN radio, which is seen in the results, which show a WLAN throughput≧10% at all LTE loads.

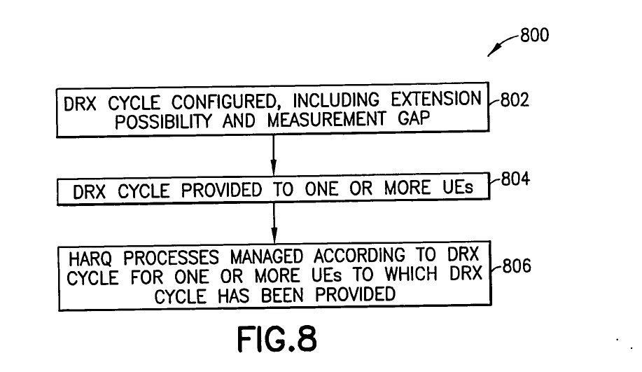

FIG. 8 illustrates a process 800 according to an embodiment of the present invention. At step 802, a DRX cycle is configured, suitably by an eNB. The DRX cycle defines a specific cycle duration. In one exemplary embodiment, the cycle duration is 40 ms, including an On-duration of 5 ms, followed by an extension possibility defined by a 5 ms inactivity timer. In addition, the cycle includes a 6 ms measurement gap during which a UE will not monitor the PDCCH channel, and will skip all HARQ retransmissions and reschedule them after the gap. At step 804, the DRX cycle is provided to one or more UEs and at step 806, HARQ processes are managed according to the DRX cycle, for one or more of the UEs to which the DRX cycle has been provided

While various exemplary embodiments have been described above it should be appreciated that the practice of the invention is not limited to the exemplary embodiments shown and discussed here. Various modifications and adaptations to the foregoing exemplary embodiments of this invention may become apparent to those skilled in the relevant arts in view of the foregoing description.

Further, some of the various features of the above non-limiting embodiments may be used to advantage without the corresponding use of other described features.

The foregoing description should therefore be considered as merely illustrative of the principles, teachings and exemplary embodiments of this invention, and not in limitation thereof.

We claim:

1. An apparatus comprising:
at least one processor;
memory storing a program of instructions;
wherein the program of instructions is configured to, with the memory and the at least one processor, configure the apparatus to perform actions comprising at least:
defining a discontinuous reception cycle, wherein the discontinuous reception cycle defines configuring at least one scheduling timer for communication with the user device; and
performing at least one of scheduling a downlink hybrid automatic repeat request process if the at least one scheduling timer is active and granting an uplink hybrid automatic repeat request process if transmission of the hybrid automatic repeat request process is due before the at least one scheduling timer expires.

2. The apparatus of claim 1, wherein configuring the scheduling timer comprises configuring a downlink scheduling timer for downlink communication to the user device and an uplink scheduling timer for uplink communication from the user device, and wherein performing scheduling a downlink hybrid automatic repeat request process is performed if the downlink scheduling timer is active and granting an uplink hybrid automatic repeat request process is performed if transmission of the hybrid automatic repeat request process is due before the uplink scheduling timer expires.

3. The apparatus of claim 2, wherein the actions further comprise bounding an inactivity timer to be at most the maximum of one of the uplink scheduling timer and the downlink scheduling timer.

4. The apparatus of claim 1, wherein timing of communication with the user device is divided into subframes and wherein the value of the scheduling timer is decreased at the end of each subframe.

5. The apparatus of claim 2, wherein the downlink scheduling timer expires upon reading a predetermined value and wherein the uplink scheduling timer expires upon reaching a predetermined value.

6. The apparatus of claim 1, wherein the discontinuous reception cycle defines an off-cycle for the user device, wherein the off-cycle is entered when the on-duration timer expires, the inactivity timer expires, and all hybrid automatic repeat request processes are terminated.

7. The apparatus of claim 1, wherein timing of communication with the user device is divided into subframes and wherein the discontinuous reception cycle defines an off-cycle for the user device, wherein the off-cycle is entered when the on-duration timer expires, the inactivity timer expires, and all hybrid automatic repeat request processes are terminated for subframes that contain at least one of acknowledge signals, non-acknowledge signals, and hybrid automatic repeat request processes.

8. A method comprising:
defining a discontinuous reception cycle, wherein the discontinuous reception cycle defines configuring at least one scheduling timer communication with the user device; and
performing at least one of scheduling a downlink hybrid automatic repeat request process if the at least one scheduling timer is active and granting an uplink hybrid automatic repeat request process if transmission of the hybrid automatic repeat request process is due before the at least one scheduling timer expires.

9. The method of claim 8, wherein configuring the scheduling timer comprises configuring a downlink scheduling timer for downlink communication to the user device and an uplink scheduling timer for uplink communication from the user device, and wherein performing scheduling a downlink hybrid automatic repeat request process is performed if the downlink scheduling timer is active and granting an uplink hybrid automatic repeat request process is performed if transmission of the hybrid automatic repeat request process is due before the uplink scheduling timer expires.

10. The method of claim 8, wherein the actions further comprise bounding an inactivity timer to be at most the maximum of one of the uplink scheduling timer and the downlink scheduling timer.

11. The method of claim 8, wherein the discontinuous reception cycle defines an off-cycle, wherein the off-cycle is entered when the on-duration timer expires, the inactivity timer expires, and all hybrid automatic repeat request processes are terminated.

12. A computer readable medium storing a program of instructions, execution of which by a processor configures an apparatus to perform actions comprising at least:
defining a discontinuous reception cycle for a user device, wherein the discontinuous reception cycle defines at least one of configuring a downlink scheduling timer for downlink communication to the user device and an uplink scheduling timer for uplink communication to the user device; and
performing at least one of scheduling a downlink hybrid automatic repeat request process to the user device only if the downlink scheduling timer is active and granting an uplink hybrid automatic repeat request process by the user device if a transmission of the hybrid automatic repeat request process is due before the uplink scheduling timer expires.

13. An apparatus comprising:
at least one processor;
memory storing a program of instructions;
wherein the program of instructions is configured to, with the memory and the at least one processor, configure the apparatus to perform actions comprising at least:
requesting a base station to configure a discontinuous reception cycle for the apparatus, wherein the requested discontinuous reception cycle comprises at least one of scheduling timer for the apparatus, wherein the at least one of scheduling timer defines time limits during which at least one of uplink and downlink hybrid automatic repeat request processes may be initiated.

14. The apparatus of claim 13, wherein the at least one scheduling timer comprises a downlink scheduling timer defining time limits wherein downlink hybrid automatic repeat request processes may be initiated and an uplink scheduling timer defining time limits wherein uplink hybrid automatic repeat request processes may be initiated.

15. The apparatus of claim 13, wherein the requested configuration further comprises an inactivity timer bounded to be at most the maximum of one of the uplink scheduling timer and the downlink scheduling timer.

16. The apparatus of claim 13, wherein timing of communication between the base station and the apparatus is divided into subframes and wherein the requested configuration comprises decreasing the value of the at least one scheduling timer at the end of each subframe.

17. The apparatus of claim 13, wherein the discontinuous reception cycle defines an off-cycle for the user device, wherein the off-cycle is entered when the on-duration timer expires, the inactivity timer expires, and all hybrid automatic repeat request processes are terminated.

18. The apparatus of claim 13, wherein timing of communication by the apparatus is divided into subframes and wherein the discontinuous reception cycle defines an off-cycle, wherein the off-cycle is entered when the on-duration timer expires, the inactivity timer expires, and all hybrid automatic repeat request processes are terminated for subframes that contain at least one of acknowledge signals, non-acknowledge signals, and hybrid automatic repeat request processes.

19. An apparatus comprising:
at least one processor;
memory storing a program of instructions;
wherein the program of instructions is configured to, with the memory and the at least one processor, configure the apparatus to perform actions comprising at least:
defining a discontinuous reception cycle, wherein the discontinuous reception cycle includes a measurement gap such that hybrid automatic repeat request process retransmissions are skipped during the measurement gap.

20. The apparatus of claim 19, wherein defining the discontinuous reception cycle further comprises defining an on-duration and positioning the measurement gap immediately before the beginning of the on-duration.

21. The apparatus of claim 19, wherein defining the discontinuous reception cycle further comprises defining an inactivity timer following the on-duration.
